(19) United States
(12) Patent Application Publication
(10) Pub. No.: US 2023/0274082 A1
(43) Pub. Date: Aug. 31, 2023

(54) SMART FORM MANAGEMENT SYSTEMS AND METHODS

(71) Applicant: Oracle International Corporation, Redwood Shores, CA (US)

(72) Inventor: Mirza Naeem Afzal, Mountain House, CA (US)

(21) Appl. No.: 17/681,497

(22) Filed: Feb. 25, 2022

(51) Int. Cl. G06F 40/174; G06F 40/197

(52) U.S. Cl. CPC G06F 40/174; G06F 40/197

(57) ABSTRACT

A smart form management system configured to: (i) provide an administrative GUI that enables a user to identify a first subset of data components from a form data structure definition for a first version of a form; (ii) create and store a first form design including a first version component list identifying the first subset of data components for the first version of the form; (iii) create, based on first user input, an instruction-driven data component including first user-defined instructions configured to be performed in response to an interaction with a first instance of the form; (iv) display the form, including content defined by one or more of the first subset of data components and enabling another user to populate one or more other of the first subset of data components; and (v) upon user interaction, perform the first user-defined instructions to generate an output.

### TECHNICAL FIELD

The field of disclosure relates generally to form management and, more particularly, to smart electronic form management systems and methods.

### BACKGROUND

Government agencies often manage and control aspects of residential and commercial development projects using various types of forms such as building permit applications, inspection certifications, and the like. The issuing agencies construct these particular forms with various fields and other form content based on needs specific to the particular use case, often including content such as applicant information, request details, application requirements, fee information, and the like. Historically, these forms may have been physical paper forms that were created and circulated by the agencies to residents, developers, contractors, or the like, and those forms would be manually completed and submitted back to the agency for processing. However, some of this form content may change over time. For example, some of this form content may be governed by factors such as federal, state, or local law, regulation, or ordinance, and such changes may mandate agencies to update their forms. These changes typically force the drafting agency to manually create and circulate a new version of the form with consideration to the changed conditions. Such version management can create challenges for both the issuing agencies and the various users of the form.

Such conventional form management practices lack features and support that can be provided in an online environment. What is needed is a smart form management system that can provide form publishers with tools that provide versioning support for form management that overcomes various technical challenges of the known systems and provides integration with third-party systems to help facilitate novel cross-platform utilities to expand on conventional form features in an online environment.

### SUMMARY

In one aspect, a smart form management system comprising is provided. The smart form management system includes at least one processor executing instructions that cause the at least one processor to: (i) provide first content configured to cause to be displayed an administrative graphical user interface (GUI) configured to enable a user to identify a first subset of data components from a form data structure definition to include in a first version of a form; (ii) create and store a first form design including a first version component list identifying, from the form data structure definition, the first subset of data components as being included in the first version of the form; (iii) create, based on first user input, an instruction-driven data component included in the first version of the form, the instruction-driven data component including first user-defined instructions configured to be performed in response to an interaction with a first instance of the form; (iv) provide second content configured to cause to be displayed the first instance of the form, including content defined by one or more of the first subset of data components and enabling another user to populate one or more other of the first subset of data components; and (v) upon user interaction with the first instance of the form, perform the first user-defined instructions to generate an output.

In another aspect, a computer-implemented method of managing electronic forms is provided. The method includes providing first content configured to cause to be displayed a user interface configured to enable a user to identify a first subset of data components from a form data structure definition to include in a first version of a form. The method also includes creating and storing a first form design including a first version component list identifying, from the form data structure definition, the first subset of data components as being included in the first version of the form. The method further includes creating, based on first user input, an instruction-driven data component included in the first version of the form, the instruction-driven data component including one or more of a trigger condition and a triggered action that includes first user-defined instructions. The method also includes providing second configured to cause to be displayed the first instance of the form, including content defined by one or more of the first subset of data components and enabling another user to populate one or more other of the first subset of data components. The method further includes, upon user interaction with the first instance of the form, causing the first user-defined instructions to be performed to generate an output.

In yet another aspect, a non-transitory computer-readable medium storing instructions is provided. When executed by at least one processor, the instructions cause the at least one processor to: (i) providing first content configured to cause to be displayed an administrative graphical user interface (GUI) configured to enable a user to identify a first subset of data components from a form data structure definition to include in a first version of a form; (ii) create and store a first form design including a first version component list identifying, from the form data structure definition, the first subset of data components as being included in the first version of the form; (iii) create and store a second form design including a second version component list identifying, from the form data structure definition, a second subset of data components as being included in the second version of the form, the second subset of data components being different than the first subset of data components; (iv) create a first instance of the form based on one of the first version design and the second version design; (v) provide second content configured to cause to be displayed the first instance of the form, including content defined by one or more of the first subset of data components; and (vi) upon user interaction with the first instance of the form, perform first user-defined instructions to generate an output.

### BRIEF DESCRIPTION OF THE DRAWINGS

FIG. 1 is a network diagram of an example smart form management system that provides various form management services to form publishers and form users.

FIG. 2 is a data structure diagram that illustrates various data components and structures used by the smart form management system to define and configure the forms, and particularly the form design, shown in FIG. 1

FIGS. 3A to 3F illustrate a sequence of screens provided by the admin interface of the form management service as viewed by the administrative user on the administrative computing device during management of forms shown in FIG. 1.

FIGS. 4A to 4F illustrate another sequence of screens provided by the admin interface of the form management service while the administrative user adds a field to the form.

FIGS. 5A to 5C illustrate another sequence of screens provided by the admin interface of the form management service while the administrative user edits a form-wide validator the form.

FIG. 6 is a block diagram that illustrates a computer system upon which an embodiment of the invention may be implemented.

FIG. 7 is a flow chart illustrating an example computer-implemented method of managing electronic forms such as the forms shown and described in FIGS. 1-5C.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present disclosure.

### 1. General Overview

Some form management applications may allow “form publishers,” such as governmental agencies, to create and deploy various types of forms in an online environment (e.g., via the Internet). These form designs may be configured by administrative users based on the content desired to be shown or collected as instances of the forms are created and used in day-to-day operation. Once a form is designed and deployed, such form instances may be created and populated by “form users,” such as residents, builders, architects, inspectors, and the like (e.g., in the example use case involving government agencies working with residential and commercial property developers). As changes to forms are needed, the form publishers may create and deploy new versions of the forms. However, technical limitations of conventional form management applications may only allow the form publishers to create a separate copy of the original form design and modify that copy based on the desired changes. For example purposes, the examples provided herein are presented in the context of residential and commercial property development and permitting with local government agencies, but many other use cases are possible.

A smart form management system is provided herein that provides technical improvements to various aspects of known form management. In an example embodiment, the smart form management system described herein is provided as a software-as-a-service (SaaS) offering (e.g., as a cloud service via the Internet). A form service provider operates a form server and associated online applications that may be used by form publishers, form users, and possibly third-party service providers to create and manage smart forms in an online environment. In various examples provided herein, the form publishers are governmental agencies such as state or local governments and the forms may be associated with various types of building permits or plans, inspection certifications, zoning approval forms, or the like. Form users are those people or entities, such as residents, business entities, commercial or residential builders, inspectors, or the like, that complete aspects of the forms (e.g., entering information into the forms, completing requirements identified on the form, and such, as part of a building or construction project, home remodeling project, or the like).

The smart form management system provides a design interface that allows form publishers to create, design, and publish smart forms for their various constituents. For example, a local government agency may design an application for a mechanical permit that residents submit, for example, when they are planning mechanical modifications or improvements to their residential dwelling. The design interface allows the form publisher to create the structure of the form, identifying various data fields that the applicant would populate with data before submission of the application for review by the government agency. For example, a form designer for the government agency may use the design interface to create one or more pages for the application, identify what data fields (e.g., data types, field names) and other text will appear on instances of the form, define work flows and various responsibilities and interactions for different form users, define configuration settings for the form, and the like. The form design includes data structures and settings that define the form and the various data components of the form (e.g., a form template). When the form designer has completed the design of a particular form, the design interface allows the form designer to publish the form for use by the targeted form users.

The smart form management system also provides a user interface that allows those constituents (e.g., the form users) to interact with instances of the forms. For example, an applicant, such as a resident of a dwelling in a local jurisdiction, may create an instance of the mechanical permit application and begin populating data fields identified on the form. Creation of an instance of the form causes the smart form management system to allocate persistent memory for the form instance (e.g., space in a supporting database) based on the form design. Some forms may be configured to allow other parties to interact with the form during the life cycle of the form instance, such as may be defined by a workflow of the form. For example, the mechanical permit application may include data components that are populated by a contractor hired by the applicant to complete the work. The term “smart form” may be used herein for the example forms, as the smart form management system provides additional technical features (or “smart features”) to form management beyond merely showing data fields of a form and accepting user input data entered into those fields. Various such smart features are described herein, including electronic form design and management utilities, versioning of forms and associated version management and presentation, field validation using user-defined instructions, triggered actions, integration of third-party application services, and various related features.

Some smart forms, such as the example mechanical permit, may need to be changed over time. For example, fees for the mechanical permit may be increased in future years, or changes in building codes or local laws may mandate new or different data fields or workflows for new instances of the forms. As such, the smart form management system described herein provides aspects of version management that allow form publishers to create and maintain multiple versions of a particular form. For each particular family of forms (e.g., one form having multiple versions), the smart form management system creates a superset of data components (“component superset”) for the form family. When a first version of the form is designed, all of the data components added to that first version are added into the component superset. Further, a version layout for the first version is created that identifies each of the data components from the component superset that are defined (e.g., mapped) to that first version.

When a second version of form is created, the system creates a second version layout that initially includes the data components of the previous version, but the design interface also allows the form designer to add, delete, or modify any of the data components for the second version (e.g., adding or removing fields, changing fields, settings, page configurations, or the like). Any data components that remain unchanged between the two versions thus use the same underlying data component in the form design (e.g., mapping the same data component from the component superset in each of the versions). For data components that are removed from this second version, the system unmaps those data components from the second version (e.g., removing that mapping from the second version layout). For data components that are added to the second version, the system creates a new data component in the component superset and adds the data component into the second version layout. Similarly, for data components that are modified from one version to the next, the system treats this modification as a combination of an addition and a deletion. More specifically, the system unmaps the original (e.g., first version) data component from the second version layout, but additionally adds a new data component for the modified field to the component superset and maps that second version data component in the second version layout. The second version data component is initially copied using the first version structure of that data component, then the designer is allowed to modify the second version data component as needed. As such, any first version instance of the form maps the first version data component (e.g., with the initial component configuration), and any second version instance maps the second version data component (e.g., with the modified component configuration).

This versioning method provides technical improvements over conventional systems that, for example, duplicate the first version of a form when creating a second version. In such a conventional approach, the first and second versions of the form would have separate, independent data structures that are duplicative for unchanged components. This separation creates performance and management issues in certain implementations. For example, if the data components for a form are defined as fields (e.g., columns) of a database table, creating a new version of the form would require a new table to be created for the second version, where the second table’s columns are changed based on the changes needed in the second version. Having multiple different tables for the same form family causes the underlying database software to manage multiple different data structures for each of the tables, leading to greater memory requirements and increased processing demands.

In the present smart form management system, one database table may be used for multiple versions of the same form. For example, the component superset may be defined as all of the columns of the same table, where each version layout identifies which of the data components (e.g., which of the columns) are used for each particular version of the form family. Such a configuration allows the underlying database to manage less tables than the example conventional system, thereby decreasing memory requirements and decreasing processing demands.

The smart form management system also provides additional technical improvements over conventional online forms in conjunction with or in addition to the versioning described above. In some embodiments described herein, the smart form management system allows the form designer to configure various data components with user-defined instructions (e.g., scripted logic, programming code, or the like) that may be automatically executed based on certain detected conditions. The design interface may, for example, provide a text editor that allows the form designer to enter the user-defined instructions that can be executed by the system during certain situations (e.g., when certain trigger conditions are satisfied). When the trigger conditions are detected, the system executes the user-defined instructions to perform whatever processing the form designer intended.

One example of a user-defined instruction component is a field validator. The field validator acts as an attachment to a particular data component (e.g., a data field) and includes user-defined instructions that are executed by the system upon some trigger condition. Field validators may be used, for example, to inspect and verify data entered into the field (e.g., enforcing a range for numerical data fields, spell checking text data fields, validating data matches one of a list of elements, or the like), to change or remove the data entered into the field (e.g., upon detection of an error), or to influence other data components of the form (e.g., populate another data field based on data entered into this field). The field validator includes user-defined instructions that are executed, for example, whenever data is entered into that particular field, or whenever data in that particular field is changed (e.g., manually or automatically). Similarly, a form validator is another example user-defined instruction component. The form validator operates similar to the field validator, but may attach more broadly to the form or page of the form and not necessarily to a particular field. Form validators may be triggered by conditions such as an initial loading of the form, any change to the form or to particular fields of the form, or successful completion of particular fields on the form. Further, as described above, field and form validators may also be added, removed, or modified between form versions as well, thereby allowing a data component to have different field validators (e.g., differences in the user-defined instructions) between different versions.

Another example user-defined instruction component is a triggered action. A triggered action also includes a triggering condition and execution of user-defined instructions (e.g., to perform some particular action). One example triggered action includes a locally performed action, such as execution of the defined user-defined instructions. A local triggered action may operate similar to field and form validators, executing some instructions that are performed locally (e.g., on the system itself). An external triggered action, in contrast, performs the particular action via interaction with an online third-party service (e.g., for acquiring data from or submitting data to the third party, for executing a third-party service, or the like). For example, the form designer may configure a button on the form that, when pressed, triggers an application programming interface (API) call to a third-party service to acquire data for the form, verify some form data, perform an online signature service or an online payment, or the like. Some external triggered actions may be triggered when data is populated into a field, or when a number of criteria have been completed on the form. The system provides an interface that allows the form designer to configure the triggering condition(s) and the triggered action(s) for the external triggered action via the user-defined instructions.

One or more embodiments described in this Specification and/or recited in the claims may not be included in this General Overview section.

### 2. System Architecture

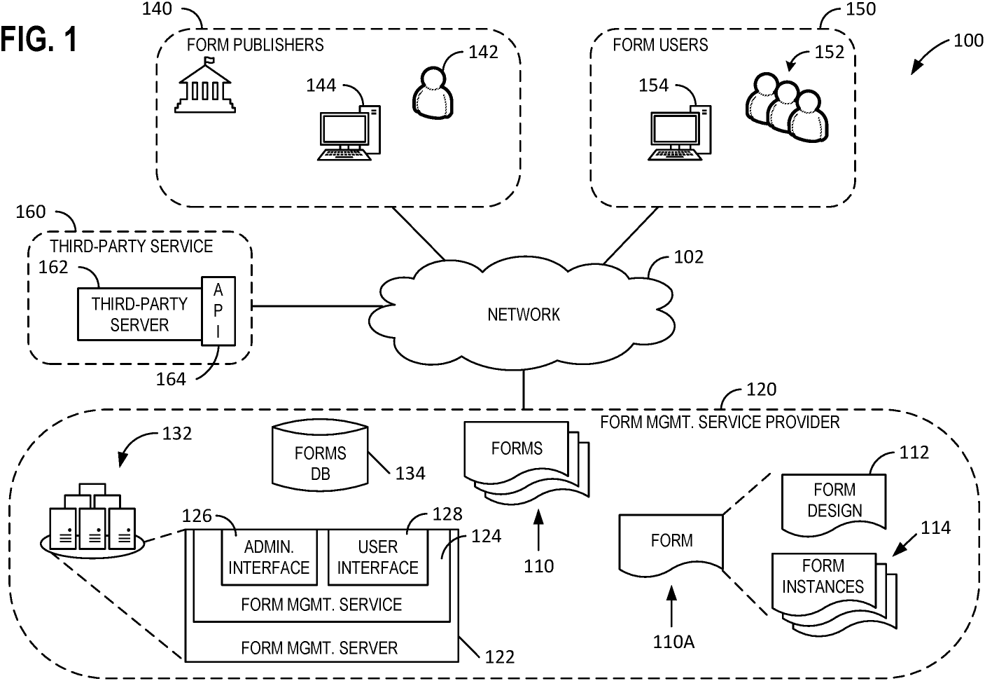

FIG. 1 is a network diagram of an example smart form management system 100 that provides various form design and management services to form publishers 140 and form users 150. In the example embodiment, a form management service provider 120 executes a smart form management application (or “form management service”) 124 on a form management server 122. Form management service 124 provides online access to various forms 110 via a computer network 102 such as the Internet. FIG. 1 illustrates two types of users of the service 124, including form publishers 140 and form users 150. Form publishers 140 may represent businesses or organizations, such as government agencies, that manage certain types of interactions with their constituents (e.g., private residents, commercial business entities, or the like, as one type of form user 150) using various types of forms 110. While many of the examples provided herein are described in the context of a government agency (e.g., as the form publisher 140) publishing permit applications (e.g., as the forms 110) to their constituents (e.g., as the form users 150), it should be understood that many other use cases are possible for the smart form management system 100 described herein. It should be further understood that the term “form management” is used broadly to refer to aspects of form design, publication, creation, editing, review, processing, completion, reporting, accounting, and various other support and implementation aspects of forms, including the various examples described herein.

In the example embodiment, the form management server 122 is a virtual server provisioned from a cloud architecture 132 and includes various computing components (e.g., central processing units (CPUs), memory, networking hardware, and the like) sufficient to perform execution of the form management service 124 and associated functionalities as described herein. Further, the example form management service 124 is provided (e.g., to form publishers 140 and their associated users 150) as a SaaS application service offering executed in the cloud architecture 132, and may, for example, dedicate a physical machine or provision a virtual machine in the cloud architecture 132 as the form management server 122 for execution of the form management service 124. In some embodiments, the form management system 100 may provide the herein described functionalities and content to the computing devices 144, 154 in a browser-based architecture (e.g., transmitting content that is rendered by a local browser), in an application-based architecture (e.g., client/server architecture with a client application installed locally on the user computing devices), or the like. It should be understood that other hardware architectures, form publishers, and form users are possible.

Forms 110 represent an online, virtual, and smart embodiment of what may have historically been published and circulated as physical paper forms or printable form images. In the example embodiment, each particular form 110A includes a form design 112 and may include one or more instances of that form (or “form instances 114”). A form design 112 is created by the form publisher 140 and defines various pages, data fields, descriptive or instructional text, user-defined instructions, and other such content and functionality used to complete a form 110. The form design 112, in other words, is a data structure definition of all of the contents of the form, including various data components that define, for example, what inputs the permit application will accept from the applicant, what data will be shown to the applicant, and how various other form functionalities described herein will be performed when this application is presented (e.g., when displayed on a remote computing device, such as devices 144, 154). These various parts of the form design are referred to herein as data components of the form 110. When a particular form user 152 creates an instance 114 of a particular form 110, the form design 112 is used as a template to create that form instance 114. In other words, the form design 112 defines the data structures of the form 110, where each instance 114 of that form 110 allocates persistent memory for that instance based on the form design 112. The term “form” may be used interchangeably herein to refer to a particular form design 112, to a particular form instance 114, or to both, depending on context.

In the example embodiment, the form management service 124 provides a graphical administrative interface (or just “admin interface”) 126 through which form publishers 140 administer their own library of forms 110 (e.g., via an administrative computing device 144). The admin interface 126 allows a form administrator 142 to create form designs 112 (e.g., define the structure and contents of forms 110), publish those forms 110 for use by form users 150, and manage instances 114 of those forms 110 created by form users 150. For example, a county government may require property owners to submit a mechanical, electrical, or plumbing permit application whenever the property owner anticipates performing certain types of work or improvements to a property within the agency’s jurisdiction. As such, the form administrator 142 may use admin interface 126 to create a form design 112 for the permit application. The admin interface 126 allows the form administrator 142 to create a new form family for the permit application, create a first version of the permit application, configure various settings for that permit application, add pages to the permit application, and add data fields and text to the permit application, and the like.

After the form administrator 142 completes the form design 112 for this example form 110 (e.g., the permit application), the form administrator 142 may publish the form 110 for use. Publication of the form 110 allows form users 150 to create their own instances 114 of the form 110 within the system 100. In the example embodiment, the form management service 124 provides a user interface 128 through which form users 152 create, manage, or otherwise interact with instances 114 of the forms 110 (e.g., via user computing devices 154). More specifically, the user interface 128 allows form users 152 to create form instances 114 of particular forms 110 (e.g., for designs 112) published by the form publisher 140 and interact with those form instances 114 (e.g., filling out data fields and the like). For example, a property owner may plan to have an air conditioner or heater (HVAC) replaced in their residential home, and their local jurisdiction may mandate submission and approval of a mechanical permit application prior to start of that work, and may also mandate inspection of the work after completion. As such, the property owner (the “applicant,” as one example form user 152) may use the user interface 128 to initiate creation of a form instance 114 of the mechanical permit application (e.g., as form 110A) published by their county government (e.g., as form publisher 140). Upon submission of this creation request, the form management service 124 creates the form instance 114 on behalf of the submitting user 152, using the form design 112 associated with that form 110A as the template for this new form instance 114. Further, in addition to the applicant, the form management system 100 may also allow other parties to be users 152 of the form instance 114. For example, some forms 110 may be configured to include participation (e.g., additional inputs, certifications, signatures, or the like) from contractors or sub-contractors performing the underlying work, inspectors (e.g., certifying the work after completion), utilities (e.g., certifying utility tasks), banks (e.g., certifying financing), emergency services (e.g., certifying safety inspections), or other government agencies. Such parties may interact with the form instances 114 via the user interface 128.

In the example embodiment, form designs 112 and various form instances 114 of forms 110 are stored in a forms database 134 that is accessible by the form management service 124. Each form design 112 may be assigned to a particular form publisher 140, and each form instance 114 may be assigned to a particular form user 152, such as the form user 152 that created that form instance 114 (the permit applicant, in this example).

In some embodiments described herein, the form management service 124 may be configured to provide versioning with forms 110. During the lifecycle of some forms 110, form publishers 140 may wish to change aspects of the form design 112. For example, fees for the permit application may increase, necessitating a change to the permit application, or requirements for completing the permit application may change, necessitating a change in the content shown or data collected on the permit application. As such, the form designer 140 may wish to create a new version of the permit application and publish that new version for new permit applications.

In the example embodiment, the service 124 supports various versioning functionalities for forms 110. More specifically, each form 110A can have multiple versions (e.g., designated by a version number or the like), where each form design 112 and each form instance 114 is associated with a particular version of that form 110A. The term “form family” is used herein to describe all of the form designs 112, form instances 114, version information, and such, associated with a particular form 110A.

For example, when a form design 112 for a new form 110A is initially created, that form design 112 may be assigned to a first version of that form 110A. Any form instances 114 created using that first version form design 112 are also associated with that first version. When the form publisher 140 wishes to create a second version of that form, a form design 112 for the second version is created. The second version form design 112 is initially created identical to the first version. The admin interface 126 allows the form administrator 142 to modify the second version form design 112 in the same way the first version form design 112 was created (e.g., allowing the administrator 142 to add or delete data components or modify existing components of the form 110A). When the publisher wishes to publish and make the second version active, the service 124 makes the second version the active version of the form 110A and any form instances 114 subsequently created will use the second version form design 112 to create the new form instances 114 and associate those instances 114 with the second version. Form versioning is described in greater detail below.

In some embodiments described herein, the form management service 124 may be configured to provide triggered actions with forms 110. Triggered actions are functionality that may be attached to data components of forms 110 (e.g., attached to fields, pages, or the form itself). These triggered actions may include user-configurable (or “user-defined”) instructions that define when an action is triggered (“trigger conditions”) and/or what operations to perform when that action is triggered (“triggered actions”). The admin interface 126 provides a text editor that allows the form administrator 142 to enter user-defined instructions (e.g., in a scripting language, regular expression (REGX), or the like) for either or both the trigger conditions and the triggered actions, thereby allowing the administrator 142 to control these parameters. The form management service 124 may use the user-defined instructions to determine when the trigger conditions are satisfied, and may use the user-defined instructions to determine what actions to perform.

One example of a triggered action is a field validator. The field validator is attached to a particular data field and is typically used to inspect the contents of data entered into the attached field. For example, a particular field of a form 110A may be intended to hold only specific contents, such as a number between a particular range (e.g., a square footage number between 100 and 1,000) or a particular text format (e.g., am email address of the form abc@xyz.com or the like). As such, the field validator may be configured to inspect field content. In some embodiments, and for example, the field validator may be configured to be triggered by a condition such as a change in the contents of the field (e.g., after the form user 152 inputs data into this field), or a change in the contents of another field, or after a particular step in a workflow or page in the form 110A is complete. The triggered action for the field validator, for example, may be configured to analyze the contents of the field, present an error if the field contents do not satisfy the contents criteria, populate data into or clear data from this or another field, or the like. The trigger condition and/or the triggered action of the field validator may be configured by the form administrator 142 using the user-defined instructions.

For example, a validator may be configured to compute a permit application fee based on data input into two other fields, such as a square footage of the property (e.g., a base fee of $100 for square footages under 2,000 sq. ft. or $200 for square footages above 2,000 sq. ft.) and an input factor influencing the base fee (e.g., *1.5 if a “commercial property or residential property” toggle field is checked as indicating that the property is a “commercial property.” This example validator may, as user-defined instructions 250 in action logic 242, validate the data contents of the square footage field (e.g., ensuring that no alphabetic or special characters are present) and may consume the values of the fields and compute the total application fee due and populate a “application fee” read-only field with the computed value. This example validator may be configured to be triggered, for example, whenever either of the square footage or commercial/residential fields are input or changed, whenever the form instance 114 is saved, or whenever page 220 or a particular task of a workflow 222 is complete.

Another example of a triggered action is an external action. An external action is a triggered action that causes a call-out to a third-party service 160. For example, the mechanical permit may require submission of an online payment (e.g., paying a permit fee), or for submission of an e-signature (e.g., an inspector certifying that an inspection has been completed). As such, the form administrator 142 may configure an external action to engage the third-party service 160 for the particular use case. External actions may be configured to be triggered based on, for example, completion of a particular step in the work flow of the form 110A, upon submission of the form 110A for agency processing, upon entry of data into a particular field, or the like. The triggered action may include any combination of local processing operations (e.g., preparation processing steps before third-party callout, subsequent processing steps after third-party callout has been completed) and third-party callout operations to engage the particular service of the third-party service 160. The call-out to the third-party service 160 may, for example, include an API call to an API 164 provided by a third-party server 162 over the network 102, and may include various data transmissions back and forth between the form management server 122 and the third-party server 162 to complete the external action. The form administrator 142 may similarly configure the trigger conditions and/or specific details of the triggered action using the user-defined instructions for this external action.l

### 3. Data Structure Overview

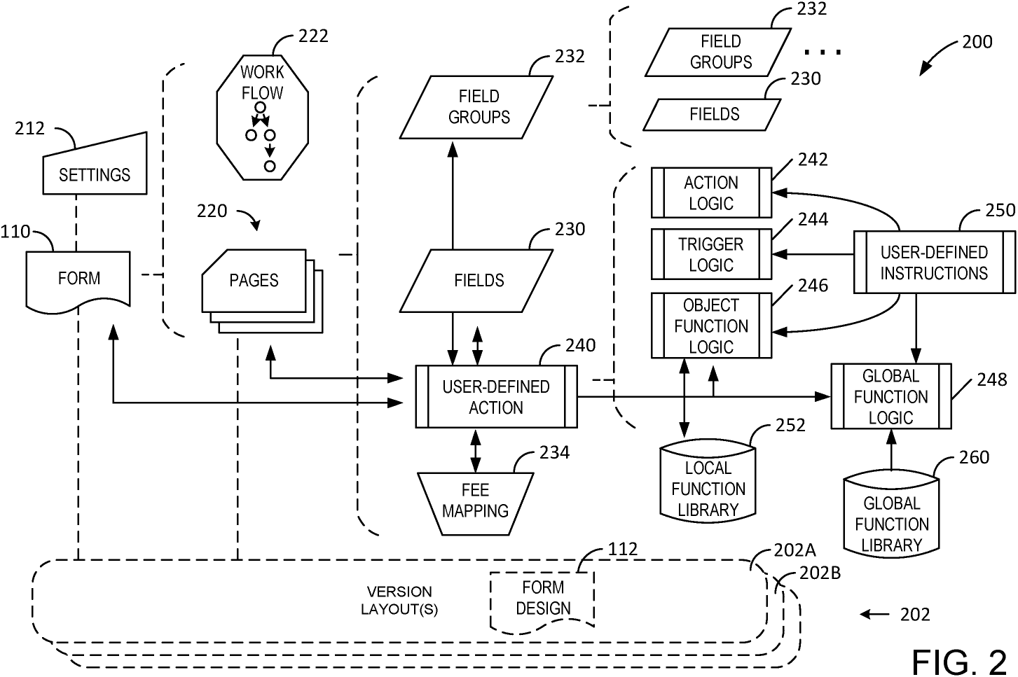

FIG. 2 is a data structure diagram 200 that illustrates various data components and structures used by the smart form management system 100 to define and configure the forms 110, and particularly the form design 112, shown in FIG. 1. In the example embodiment, a form designer, such as the form administrator 142 shown in FIG. 1, uses the admin interface 126 provided by the form management service 124 to construct the form design 112 for a particular form 110. The admin interface 126 provides a GUI that, in addition to various administrative and design controls, also includes a page view of each page 220 that renders certain data components of the page 220 similar to how the page 220 would be displayed to the form users 150 when viewing the page 220 as a form instance 114 in via the user interface 128 (e.g., showing the page in a “what you see is what you get (WYSISYG)” style to the form designer to help the designer visualize what the users 152 will see). The form design 112 is configured by the form designer specific to the needs of the form publisher 140, but contains various data components provided by the smart form management system 100 and as selected by the form designer during the design process. The resulting form design 112, once published, can be used by form users 150 to create instances of the form (e.g., the form instances 114 shown in FIG. 1). FIG. 2 illustrates various example data components supported by the smart form management system 100, as well as a hierarchy illustrating their respective relationships.

More specifically, in the example embodiment, each form 110 may be configured with one or more pages 220, where each page 220 of the form 110 may be separately configured with specific contents and may be individually displayed (e.g., similar to a paper form spanning multiple sheets of paper). The form designer adds one or more pages 220 to the form 110 and may then add data components as contents of each page. The form designer may name each page and that page name may be displayed via the interfaces 126, 128.

Fields 230 are one example data component that can be added to pages 220. Fields 230 can include several field types, including display-only fields (e.g., text, images, video, read-only data fields, or other digital content or the like that is displayed but that does not accept user input), data input fields (e.g., fields that accept user input such as, for example, text fields or areas, rich text, integer or real number inputs, date/time inputs, or the like), or user interaction fields (e.g., drop-down lists, multi-select lists, single item check boxes, check box sets, radio button sets, switches, buttons, mouse-over fields, drag-and-drop upload fields, or the like). When displayed to form users 152 (e.g., as a form instance 114 via the user interface 128), data input-type fields include a data entry object where data may be displayed and, for read/write fields, may be edited by the form users 152. Some data input-type fields may include a field label or other descriptive text, graphical icon or image, data entry instructions, or the like, that may be displayed in conjunction with the data entry object. For example, the text “Inspection Date” may be displayed next to a date/time field used to store an inspection date. The field 230 may include other attributes such as, for example, a default value, a hidden toggle (e.g., causing the field 230 to be hidden from the user view), a reusable toggle (e.g., indicating whether this field can be reused in other forms 110), a required toggle (e.g., indicating whether an input value is required to be provided), or data type formatting settings (e.g., number of decimal places for a real number data type, particular date/time format for a date data type, and the like).

Another example data component that can be added to pages 220 are field groups 232. Field groups 232 are composite data structures that can include multiple data components, such as multiple fields 230, other field groups 232 (e.g., nested field groups), or other data components. Field groups 232 may be used to bundle various related data components together into a logical structure (e.g., for ease of administrative management, for clarity or organization, for user understandability, or the like). For example, the form designer may create a field group 232 named “Property Address” that includes fields 230 for “Address Number,” “Street Name,” “Suite/Apartment Number,” “City,” and “State.” Each field group 232 may include an associated field group name that may be displayed in the admin interface 126, when the form 110 is rendered in the user interface 128, or both.

In the example embodiment, the admin interface 126 provides user controls that allow the form designer to both add a new, custom field 230 to the page 220 or to add fields 230 or field groups 232 from a set of preconfigured, “ready-to-use” data components (e.g., ready-to-use fields 230, ready-to-use field groups 232). For custom fields 230, the admin interface 126 allows the form designer to create a new custom field 230 by selecting and/or dragging and dropping a field type from a list of available field types and placing a new field at the drop location within the page view (e.g., adding a field name and input data entry object, in the case of data input-type fields). The form designer may change the displayed field name, the data type associated with the field, or other settings associated with that new field 230. When adding a custom field group 232, the admin interface 126 adds a group box to the page view, where the group box allows the form designer to subsequently add other fields 230, field groups 232, or other data components into that group box, and thus into the custom field group 232. When adding a ready-to-use component to the page 220, the form designer selects the ready-to-use field 230 or ready-to-use field group 232 from a library list of such components and drags/drops the desired component onto the page 220 at the desired position. Such additions of data components thus cause the admin interface 126 to display the modified page 220, thereby allowing the form designer to both view the page 220 similar to the user view, but also interact with the data components (e.g., for editing field attributes, changing position or structure, or the like).

The smart form management system 100 also provides a data component, the “user-defined action” 240, that may be attached to other data components, such as fields 230, field groups 232, pages 220, or the form 110 itself. This user-defined action 240 may include one or more of action logic 242, trigger condition logic (or just “trigger logic”) 244, object function logic 246, and global function logic 248. Action logic 242 defines what the user-defined action occurs, when triggered. Trigger logic 244 defines when the user-defined action is triggered. Object function logic 246 identifies any object functions that may be used in either the action logic 242 or the trigger logic 244. Global function logic 248 identifies, from a function library 260, any global functions that may be used in either the action logic 242 or the trigger logic 244. Each of the logic components 242, 244, 246, and 248 may use a set of user-defined instructions 250 to allow the form designer to customize various operational aspects of the user-defined action 240. The admin interface 126 provides a scripting window that allows the form designer to input user-defined instructions 250 (e.g., in a scripting language or other programming language, such as APACHE® GROOVY® or the like) into any or all of the logic components. These instructions 250 may be referred to herein as user-defined or user-defined instructions, as they are entered into the form 110 by the form designer or otherwise are selected to be attached to the particular data component (e.g., from the function library 260). During operation (e.g., when the form 110 is being presented to the form users 152 via user interface 128), the form management service 124 may cause any of the logic components 242-248 (e.g., the associated user-defined instructions 250) to be executed by the user interface 128, via the user computing device 154, or the like. Such execution may be triggered by different conditions based on the type of user-defined action 240, the configuration settings of the attached component, as configured within the trigger logic 244, or the like. Further, trigger logic 244 or action logic 242 may consume data entered into the form instance 114 (e.g., using, editing, or removing the values provided in fields 230 for particular uses). Various example user-defined action types and examples are provided below.

One example type of user-defined action 242 is a validator. A validator may be attached to a particular field 230 and may be used, for example, to inspect the data contents of the field 230. Such a validator is referred to herein as a “field validator.” The action logic 242 for a field validator may be programmed to, for example, ensure input data matches the associated field type, falls within a predefined numeric or date range, matches one of a set of valid values, edit or clear the contents of the field (e.g., changing text to all capitals or lower case, converting a number to a particular number of decimal places, deleting the contents on error condition), or the like. Some field validators may trigger an error message to be displayed if an error is detected during the field validation (e.g., instructing the user 152 as to the detected error).

Each field validator includes a trigger condition that identifies when the action logic 242 is executed. In some embodiments, a setting on the attached field 230 may define the trigger condition for when the action logic 242 is executed. For example, the attached field may be configured to trigger the action logic 242 when the user 152 enters data into the associated field 230, when the data contents of the field 230 are changed, or when the data contents of another field 230 is entered or changed. In some embodiments, the trigger condition may be configured to execute when a fact item or field external to this particular form 110 changes (e.g., a field from another form 110 or another document object within the system 100, an identified change in a law governing this form 110 from an internal or external source, or the like). For example, the system 100 may maintain fact records for fee worksheets (e.g., fee amounts for given property sizes, types, or the like) that may be updated as laws are changed, and such changes in these fact records may be configured to trigger an update in the fee worksheet of this form 110. In some embodiments, the trigger logic 244 defines the trigger condition. For example, the form designer may program user-defined instructions 250 that generate an output that determines if the trigger condition is met. As such, during operation, the form management service 124 may incorporate the trigger logic 244 into presentation of form instances 114 of the form, thereby actively checking when the trigger condition(s) are satisfied. Upon occurrence of the trigger condition, the form management service 124 causes the action logic 242 to be executed, thereby performing the programmed field validation as configured by the form designer.

In some embodiments, the form designer may program object function logic 246 for use in the action logic 242 or trigger logic 244. Object function logic 246 includes user-defined instructions 250 in the form of functional logic that may be referenced and incorporated within the action logic 242 or trigger logic 244 (e.g., as a function call, as a shared object, or the like). Such object function logic 246 may be shared and jointly accessible across action logic 242 or trigger logic 244 of other user-defined actions 240 within this form 110 (e.g., as a shared resource). In some embodiments, the user-defined action 240 may reference one or more global function logic 248 from the function library 260. The function library may include user-defined instructions 250 that are shared across multiple forms 110 (e.g., as a central, standardizes library).

Similar to the field validator described above, in some embodiments, user-defined actions 242 may be attached to a particular field group 232, to a particular page 220, or to the form 110 itself. Such validators may be used, for example, to inspect the data contents of various fields 230 on the page 220 or anywhere in the form 110 (e.g., ensure that specific fields have been entered properly), to compute data contents of various fields 230 (e.g., compute a total fee due based on data input in one or more other fields), to trigger additional interactions with the user 152 (e.g., prompting for entry of an e-signature before submission), or the like. Such validators may be referred to herein as “field group validators,” “page validators,” or “form validators,” respectively, and similarly include user-defined instructions 250 to be executed when a trigger condition is met.

Another type of user-defined action 240 is an external action. An external action may similarly include any or all of the logic components 242-248, including user-defined instructions 250, but an external action includes communications to one or more third-party services 160 (shown in FIG. 1) to facilitate some feature of the form 110. The communication operations associated with this third-party service 160 is referred to herein as a third-party call or a third-party service call. Such third-party calls may be configured as a part of a trigger condition (e.g., called within the trigger logic 244), as a part of a triggered action (e.g., called within the action logic 242), or both. External actions with the forms 110 may be created and customized for various uses such as, for example, retrieving data from external sources (e.g., requesting physical characteristics data, such as square footage data of a property, from an online source, requesting property value estimates, retrieving an attachment from a cloud storage folder, receive calendar data or mail from other form users, linking to online documents or online resources associated with the form, identifying liens on a property from an online public database), publishing data to external sources (e.g., posting building plans for a commercial development, copying an electronic document to a cloud storage folder), and performing transactions with third-party systems (e.g., online payment transactions, online e-signature document execution). To facilitate such third-party calls, the form management service 124 provides interface commands (e.g., within the scripting language of the user-defined instructions 250) that allow third-party API calls from the form management service 124 to the API of the third-party server 162 (e.g., a Simple Object Access Protocol (SOAP), representational state transfer (REST) style request, web API exchange as an HTTP request and response in Extensible Markup Language (XML), JavaScript Object Notation (JSON), or the like).

The user-configurable nature of the action logic 242 and/or trigger logic 244 allows form designers to build simple or complex interactions with one or more third-party services 160, as well as local actions, to complete various operations. For example, the form designer can program an external action to retrieve a value for the square footage of a commercial property from a public real estate database (e.g., based on business address or the like), locally compute a permit fee based on the property’s square footage, and automatically initiate a payment transaction for the permit fee with an online e-commerce provider. External actions which include such remote calls in the trigger logic 244 are referred to herein as “externally-dependent actions.” External actions which include such remote calls in the action logic 242 are referred to herein as “externally-performed actions.” In some embodiments, the external action may use communications with one or more third-party services 160 as factors in a trigger condition (e.g., in the trigger logic 244 of this user-defined action 240) and further use communications with one or more third-party services 160 to complete the triggered action (e.g., in the action logic 242). Such external actions that are both externally-dependent and externally-performed are referred to herein as externally-chained actions.

Numerous example external actions are possible for integration with forms 110 and various uses and scenarios (e.g., as trigger conditions or as triggered actions), and numerous online service providers may expose APIs that facilitate such communications. For example, an external action may use an online spreadsheet application (e.g., GOOGLE® DOCS™) as a trigger condition in the trigger logic 244 to detect when a change to a particular spreadsheet (e.g., when a planning spreadsheet has been updated with property dimensions), causing the associated action logic 242 to populate the form instance 114 with the data received from the spreadsheet. An external action may configure trigger logic 244 to occur whenever a form instance 114 completes a construction task (e.g., as the trigger logic 244), automatically triggering an inspection request. The associated action logic 242 may include, for example, two third-party callouts, a first that uses an online calendar application (e.g., MICROSOFT® OUTLOOK®) to generate a calendar event, and an online email service (e.g., GOOGLE® GMAIL®) to email the calendar event entry to an email address of the assigned inspector. Other example third-party services and associated services that may be used for trigger conditions or actions include online data storage services (e.g., GOOGLE® DRIVE™, DROPBOX®) for storing and sharing associated document storage, online word processing applications (e.g., MICROSOFT® WORD®, ONENOTE®) for editing related documents, document viewers (e.g., ADOBE® ACROBAT®) or multimedia players (e.g., for viewing associated documents, audio or video files of various document types, online payment processing applications (e.g., PAYPAL®) for processing application fees or paying service professionals, social media applications (e.g., FACEBOOK®, LINKEDIN®, TWITTER®) for short message service (SMS) or text messaging to or from users 152 or other vested parties to the form 110, multimedia players for playing video of footage recorded from the property, or online e-signature services (e.g., DOCUSIGN®) for recording e-signatures of the applicant, contractors, or inspectors associated with the form 110. It should be apparent that various such third-party services 160 may offer applications and APIs 164 that can be integrated as condition in trigger logic or as performable actions in action logic 242 and may be combined with any of the other conditions or actions described herein to add improved smart features to the forms 110.

For example, one example external action may be configured to prompt an electronic signature of a particular document by one of the form users 152 using an online e-signature service. As such, when this external action is triggered, the form management service 124 may transmit a request to the online e-signature server (e.g., as the third-party server 162) to initiate a document signature for a particular electronic document. The e-signature request may, for example, include a document reference ID, document link, or a copy of the document to be signed, as well as identification information of the signing user (e.g., a login ID, email address, authentication information, or the like). The request associated with this external action may thus cause the third-party service 160 to provide a user interface that allows the signing user to authenticate with the third-party service 160, apply an e-signature to the document, and record e-signature information (e.g., date/time, signature, fully executed document with the e-signature, and the like). In response, upon completion of the e-signing, the third-party server 162 may transmit a response message back to the form management service 124 that may include results of the e-signature (e.g., success of failure codes), the executed document, the date/time of execution, or the like, and in turn, the form management service 124 may update the form 110 as having completed an e-signature task for this particular user and document.

In another example, one example external action may be configured to allow form users 152 to post, edit, or update online documents associated with the form 110 using an online document storage service (e.g., a spreadsheet document, a text document, or the like). For example, the external action may allow users to post documents, link to those documents, and control access to those documents within the form 110. Upon the triggering of the external action, the form management service 124 may transmit a document upload message to the third-party server 162 that includes an electronic copy of the document (e.g., provided by the uploading user or from the form management service 124) as well as access control information (e.g., individual user credential information of the uploading user, credential information of the form management service 124). Upon receipt, the third-party server 162 may store the document and provide online access to that document on behalf of the system 100. Subsequent views, edits or updates of that document may also be provided by the third-party server 162 (e.g., when triggered by another configured external action). For example, the form management service 124 may transmit a request to access a stored document, which may include a document identifier of the document and authentication information (e.g., for the individual user, for the form management service 124, or the like). In some embodiments, the third-party service 160 may provide a user interface through which the document may be viewed or edited (e.g., as a third-party document viewer/editor). In other embodiments, the third-party service 160 may transmit a copy of the document back to the form management service 124 for local document viewing or editing (e.g., via a viewer/editor provided by the form management service 124, a viewer/editor provided locally on the computing device 154 of the requesting user, or the like). In update scenarios, the form management service 124 may subsequently transmit an updated copy of the document back to the third-party server 162 for storage.

Another example data component that may be included in form 110 is a fee mapping 234. The fee mapping 234 is a data component that determines how a fee for the form is determined (e.g., a permit application fee or the like). The fee mapping 234 identifies which data components (e.g., the data in which fields 230) impact the determination of the fee and may include a user-defined action 240 with action logic 242 that can be configured to compute the fee. For example, the action logic 242 of a fee mapping 234 for a residential building permit can distinguish between a residential remodel that does or does not add square footage to the residential property (e.g., as conditional on a “additional square footage” field value being non-zero) and can, for example, use a fixed fee for residential remodels that do not add square footage and a floating fee for residential remodels that do add square footage. The trigger logic 244 of the fee mapping 234 can be used by the form designer to define the conditions when the fee is computed (e.g., when the action logic 242 is performed). For example, the trigger logic 244 may be configured to populate a fixed “fee due” amount when the form user 152 checks a box indicating that no square footage is being added, or to compute the fee due amount when an “additional square footage” field value is entered.

In some embodiments, the form management service 124 may provide a fee estimator to form users 152 without the form user 152 starting the form creation process (e.g., without creating a form instance 114). For example, the form management service 124 may use the fee mapping 234 of the form 110 to identify only the fields 230 that impact the fee determination and may provide a user interface to the form user 152 to input just that data. Upon receipt of that input data, the form management service 124 may use the action logic 242 of the fee mapping 234 to determine the fee due and may provide that fee due value to the form user 152 (e.g., as an estimated application fee).

In the example embodiment, the smart form management system 100 provides versioning functionality for forms 110. Versioning allows the form publisher 140 to change a particular form 110A over time, or otherwise create multiple versions of the same form based on need. For example, the example mechanical permit application may change over time as local laws or ordinances change, as fees increase, or the like. To support the dynamic nature of some types of forms 110, the smart form management system 100 allows form publishers to create and manage multiple versions of a form 110A within the admin interface 126.

In the example embodiment, the system 100 initially creates a first version of the form 110A when the form designer first creates the form 110A. Each version of the form 110A includes a version layout 202 that defines the form design 112 for that version. More specifically, the version layout 202 identifies a set of all of the data components included in that version of the form 110A (e.g., all of the pages 220, fields 230, field groups 232, fee mapping 234, work flow 222, and all associated user-defined actions 240 that are initially configured for the first version of this form 110A. Each of these data components are individually stored and uniquely identifiable in a component superset for this family of forms 110. In the example embodiment, each data component is assigned to one or more fields (“physical fields”) of a database table, where columns of the table represent various data objects of the form family, where rows of the table represent individual form instances 114 of the form 110A, and where the cell values store values or other data associated with the particular data component of that particular form instance 114. The first version layout 202A for the first version includes all of the initial data components assigned to the first version of the form 110A. In other words, the version layout 202A defines the components of the form design 112 for that first version of the form 110A.

For example, consider a simple commercial building permit application for construction of a shed building at an existing commercial property. A form designer for a local government agency creates a first version of a building permit application that includes an address field, ADDR, of variable string data type, a city field, CITY, of variable string data type, a state field, STATE, of two-character string data type, and a zip code, ZIP, of integer data type. The form publisher initially puts this first version into use, allowing many commercial businesses to use the form for submission of building permit applications in the agency’s jurisdiction. Creation of this first version of the form causes the smart form management system 100 to create a table and the version layout 202A for this form design 112 of the first version with columns for each data component (e.g., for each of ADDR, CITY, STATE, and ZIP).

Some time later, the agency realizes they want to split up the ADDR field into a numerical street address and a street name to allow for easier sorting and management of forms. As such, the form designer creates a second version of the form 110A. This second version of the form 110A initially starts with a second version layout 202B identical to the first version layout 202A, thus referencing the same set of data components (e.g., the same database fields) as being included in the second version. To make the desired changes to this second version of the form 110A, the form designer deletes the ADDR field from the second version and instead adds two new fields, a street number for the property, STREETNUM as an integer, and a street name for the property, STREETNAME as a variable character data type.

As the form designer makes these changes in the admin interface 126, the form management service 124 removes the deleted data component, ADDR, from the second version layout 202B and adds two new fields (e.g., columns) to the database table, one for STREETNUM and another for STREETNAME. Removal of the ADDR data component from the second version layout 202B does not remove that column from the database table. Rather, that field is merely unmapped from the second version layout 202B, but the column remains intact in the database table. This maintains the integrity of the table for all first versions of the form 110A, which still use the ADDR field. The addition of STREETNUM and STREETNAME fields as columns in the database table creates two new fields that can be mapped in the second version layout 202B. Any second version forms 110 using the second version form design 112 will, as such, have STREET NUM, STREETNAME, CITY, STATE, and ZIP. After these additional columns are added to the database table, the columns of the resultant database table represent a “superset” of data components for the form 110A, where each particular version layout 202 identifies a “subset” of data components that are used by that particular version of the form 110A. In cases where a field is modified, the form management service 124 may treat the modification as a removal of the field in question from the next version and an addition of a new field to that new version, where the new field reflects the desired change. As such, the attributes of the old field remain unchanged for the prior version and the new version uses a new field created with the modifications made.

In the example embodiment, this versioning technique is applied to fields 230 as described above, thereby allowing data fields to be added, removed, or modified while retaining the structure of the prior version(s) and without impacting existing forms 110A under those prior versions. New forms created under the new version are added to the same table without having to create and manage a separate table for each version.

Similarly, this versioning technique can also be applied to other data objects of the forms 110, such as pages 220 of each version, field groups 232, and fee mappings 234. For example, while the first version building permit included only one page 220, a subsequent version of the example building permit may include a second page 220 with additional fields 230 or field groups 230. Similarly, a new fee mapping 234 may be added for the new version of the form 110, unmapping the original fee mapping 234 of the prior version, and thus allowing the fee mapping 234 to be different than the original version.

Further, in the example embodiment, user-defined actions 240 and/or their associated components, the action logic 242, trigger logic 244, and object function logic 246, or the referenced global function logic 248, and the associated user-defined instructions 250, may be changed from one version to the next. For example, presume the first version of the building permit application also included a field validator (e.g., as action logic 242) on the CITY field that checks to ensure no numbers appear in the city name and displayed an error if a number is so found. This first version action logic 242 may be stored as a column in the database table (e.g., as script text) and linked to the particular field 230 or user-defined action 240. In the second version of the form 110A, the form designer modifies the action logic 242 of the CITY field, also adding a check to ensure that no punctuation or special characters appear in the city name. This field modification is treated as described above, as an unmapping of the old action logic data component, adding of a new action logic data component as a column in the database table, and mapping the new column to the new version of the form 110. Both versions of the user-defined instructions 250 provided in the action logic 242 of the first version and the second version are maintained in the database for each of those versions, thereby avoiding having to create a separate database table for each new version. Similarly, other data components such as work flow 222 or settings 212 of the form 110 may be changed between versions. Work flow 222 may provide requirements (e.g., documents, approvals, inspections, fees) and dependencies or timelines (e.g., timings or ordering) for particular steps associated with processing of the form that are to be completed (e.g., by the users) for the form 110, and such work flows 222 may similarly change from one version to the next. For example, a change in law may cause an additional inspection or approval to be performed for a second version of a form 110 that was not required on an earlier version of the form 110, and thus the second version work flow 222 may include the additional requirement that is not present in the first version. As such, the smart form management system 100 provides sets of version-specific data components as well as version-specific and field-specific user-defined actions 240.

### 3. Example Administrative Interface Screens

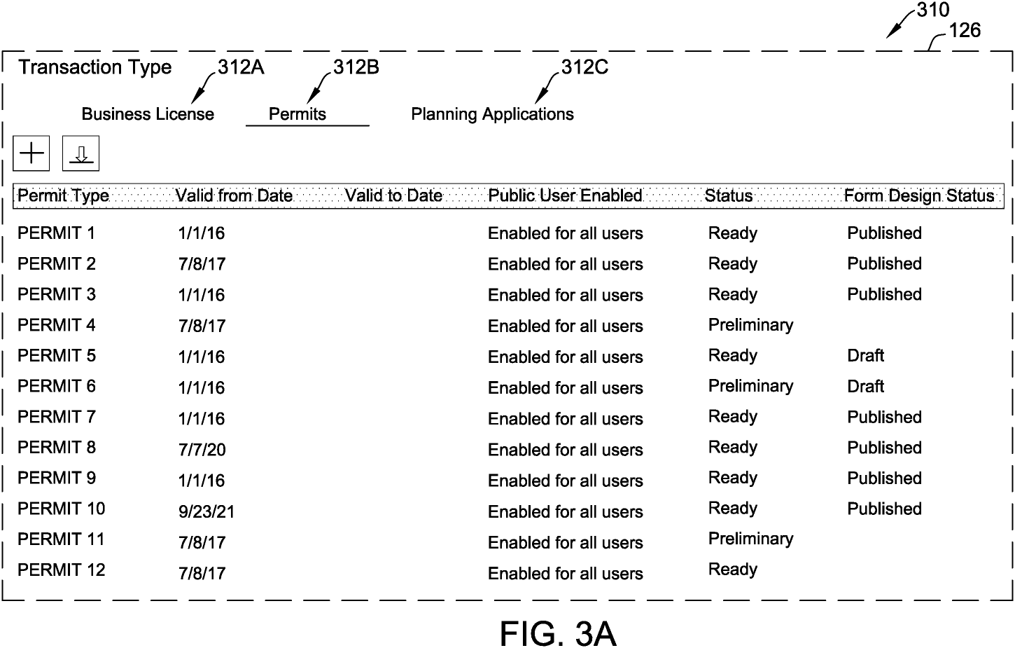

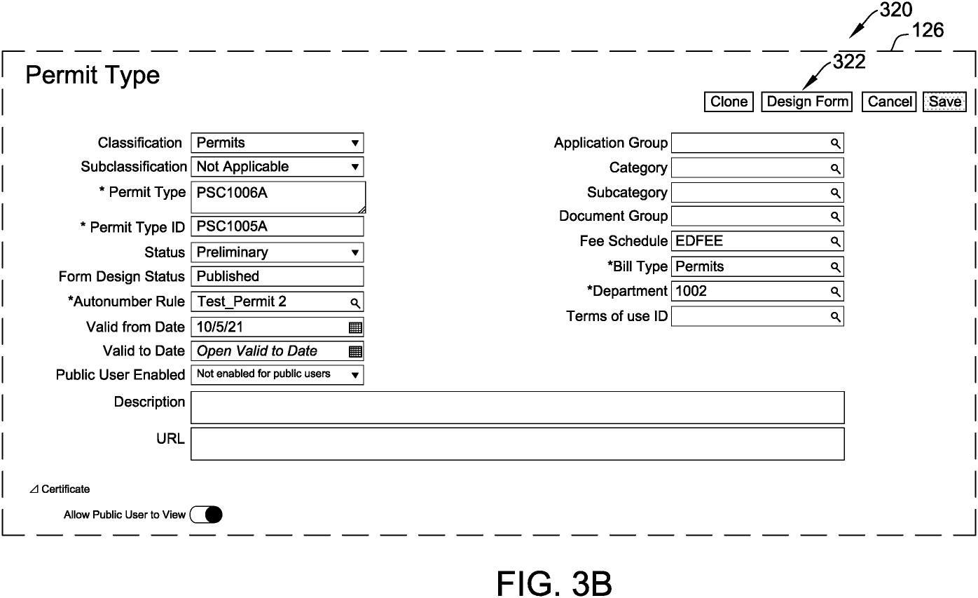

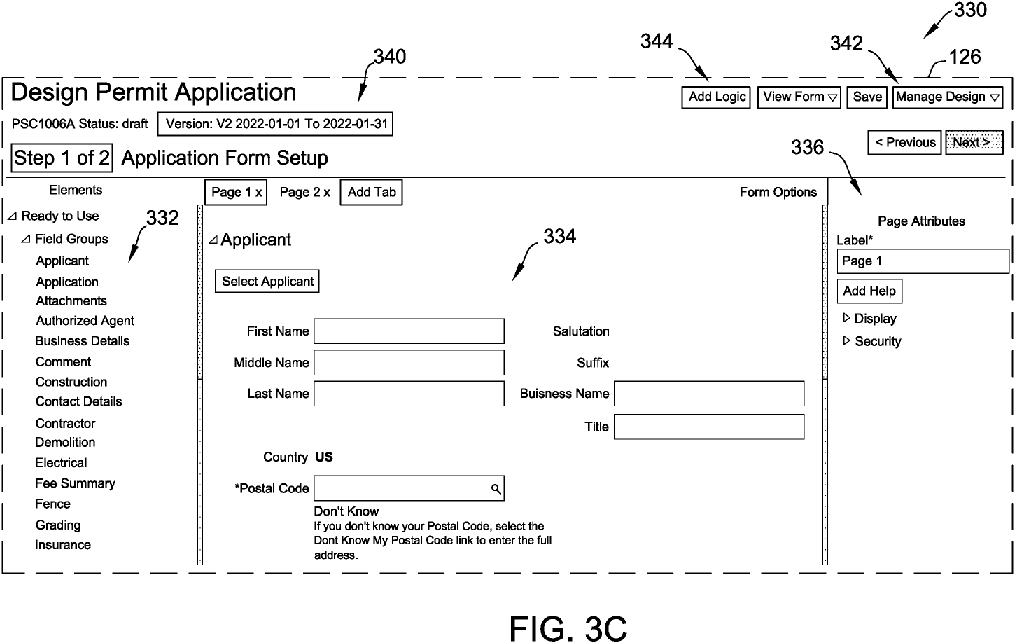

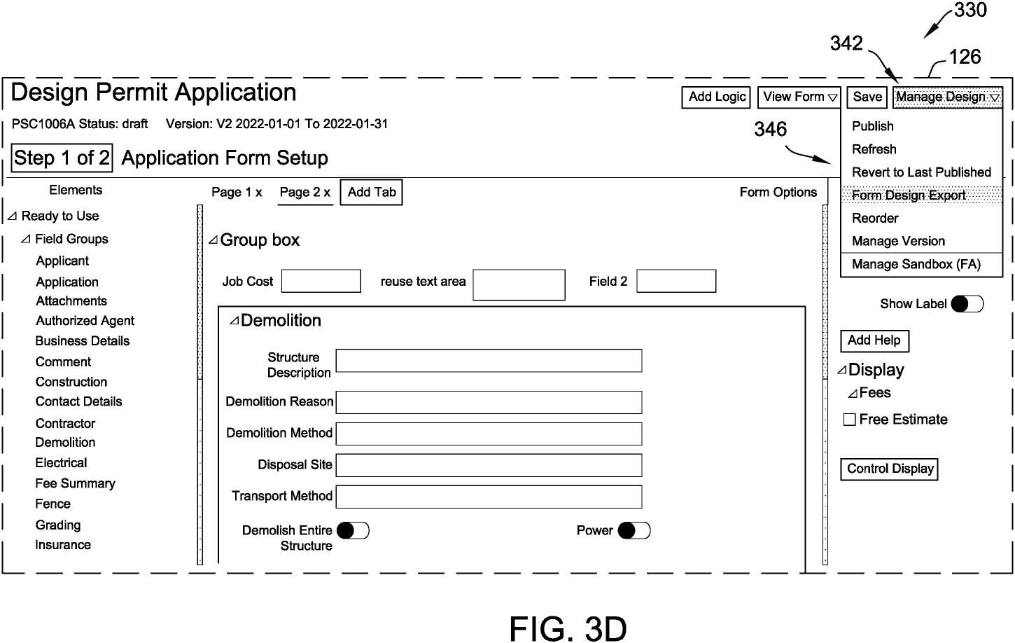

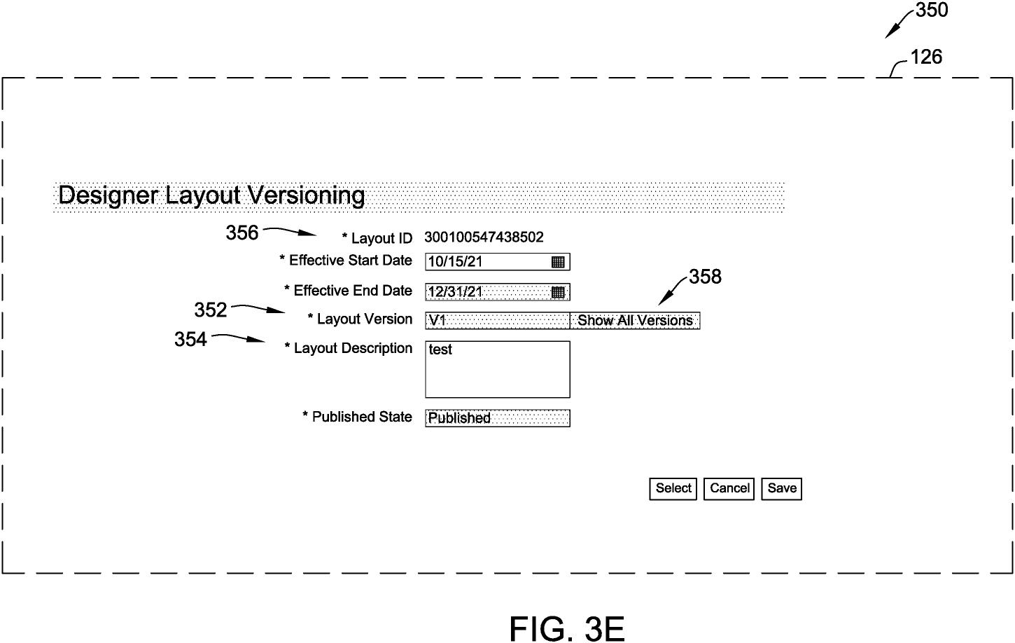

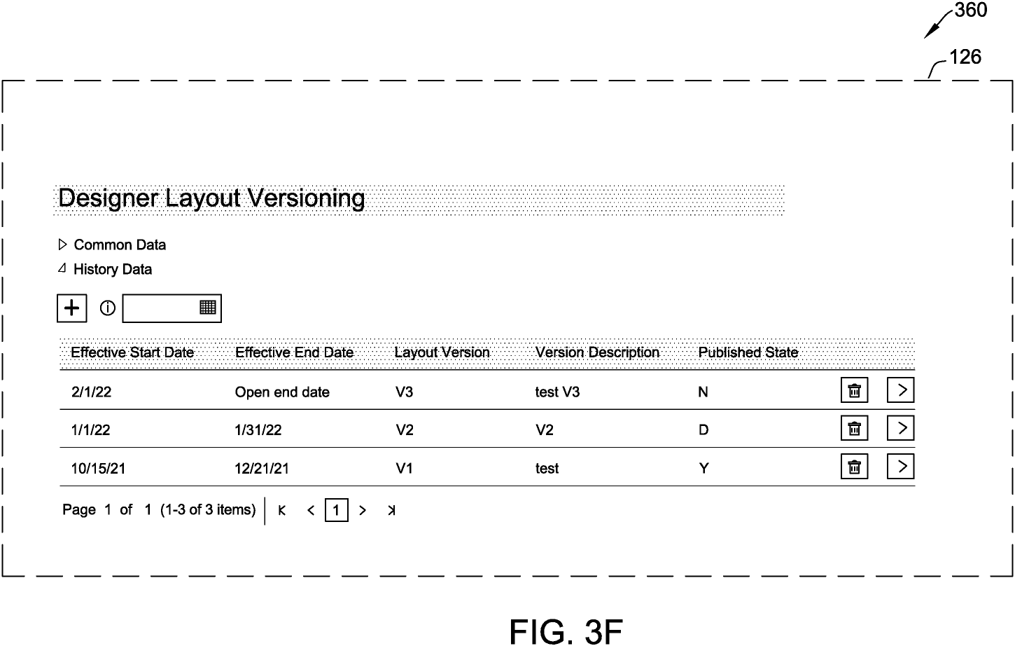

FIGS. 3A to 3F illustrate a sequence of screens provided by the admin interface 126 of the form management service 124 as viewed by the administrative user 142 on the administrative computing device 144 during management of forms 110 shown in FIG. 1. FIG. 3A is a selection screen 310 showing three tabs of transaction types (e.g., types of forms 110), including Business Licenses, Permits, and Planning Applications, each of which displays a list of stored form types. In the example shown here, the Permits tab is selected and the screen shows a list of permit types that have been previously created and stored in the forms database 134, where each row identifies an individual form 110 or form family (e.g., for those forms 110 with multiple versions). Permit Type indicates a user-defined name for the form 110. Valid From and Valid To Date columns identify when that form 110 is or was active. Public User Enabled, Status, and Form Design Status provide additional state information for the each particular form. After the administrative user 142 clicks upon a particular Permit Type (e.g., a particular form 110), the admin interface 126 displays the example permit type screen 320 shown in FIG. 3B. The permit type screen 320 includes various configuration settings and attributes of this form 110, entitled Permit Type of “PSC1006A” in this example. The permit type screen 320 may show various configuration settings similar to settings 212 shown in FIG. 2, some or all of which may be edited and saved on this screen 320.

Upon clicking the “Design Form” button 322, the admin interface 126 displays a form design interface 330, entitled Design Permit Application, that allows the administrative user 142 to modify the example form 110. The form design interface 330 includes a components pane 332 on the left side of the interface 330, a page design pane 334 in the middle, and an attributes pane 336 on the right. The page design pane 334 includes a tab for each page 220 defined for this example form 110. The components pane 332 shows a list of “ready-to-use” components that may be added to the page by dragging and dropping the component from the components pane 332 into the page design pane 334. The attributes pane 336 changes based on which data component is selected within the page design pane 334. The design interface 330 also displays a version identifier 340 showing what version of the form 110 is currently being shown and edited.

The design interface 330 allows the administrative user 142 to change which version of the form 110 is being edited by selecting a Manage Design button 342. FIG. 3D illustrates a drop-down menu 346 for the Manage Design button 342 that includes a list item Manage Version. Upon selection of the Manage Version list item, the admin interface 126 displays a Designer Layout Versioning screen 350 as shown in FIG. 3E. The versioning screen 350 shows a layout version 352, “V1,” for the current version of the form 110 being edited, a version description 354, a layout ID 356 (e.g., uniquely identifying the version layout 202 associated with this form 110 and version 202), and additional settings for the current version. The versioning screen 350 also includes a Show All Versions button 358 that may be used to view versions of the current form 110. Upon selection of the Show All Versions button 358, the admin interface 126 displays a Designer Layout Versioning screen 360 as shown in FIG. 3F. The versioning screen 360 shows rows for each individual version of the current form 110, as well as the effective start date and end date of each version, a version description, and a published state. This example form 110 includes three versions, “V1,” “V2,” and “V3.”

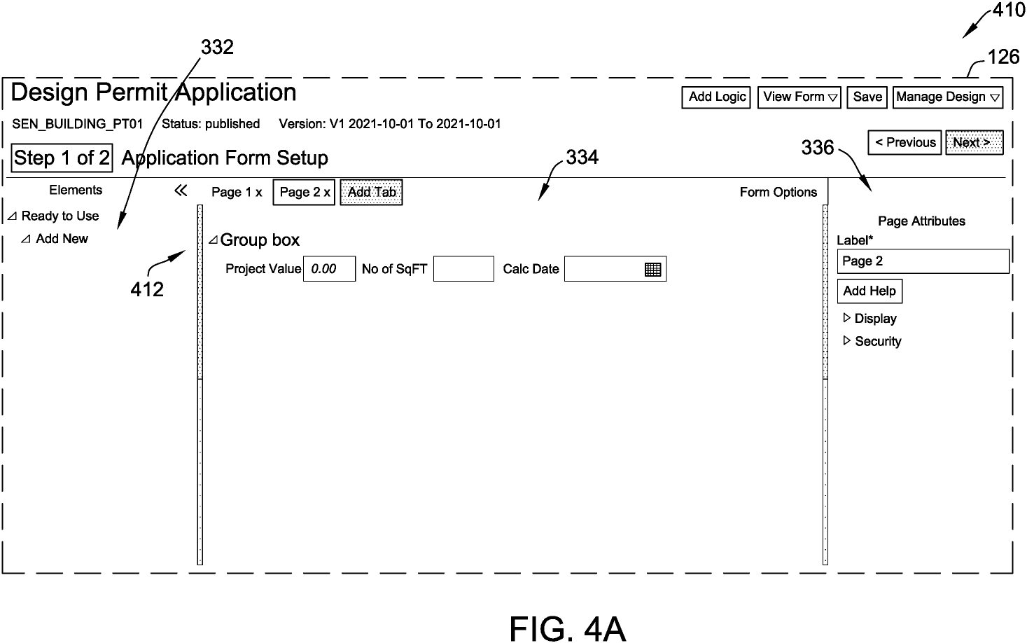

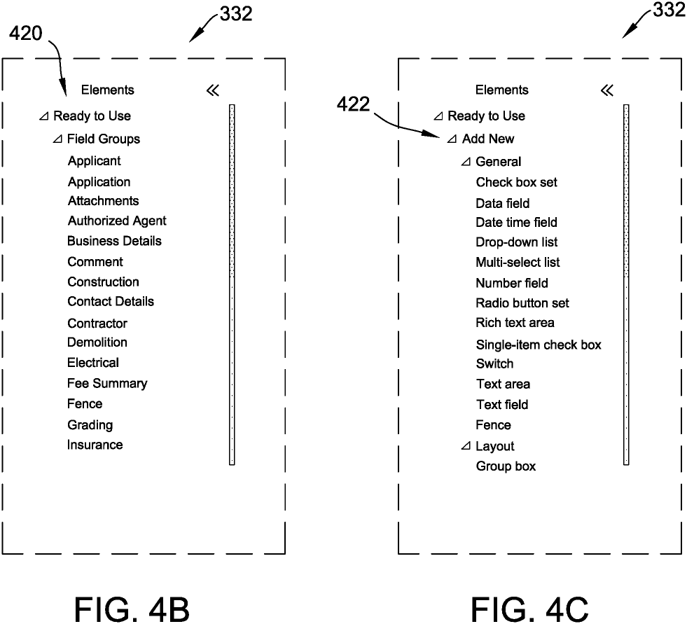

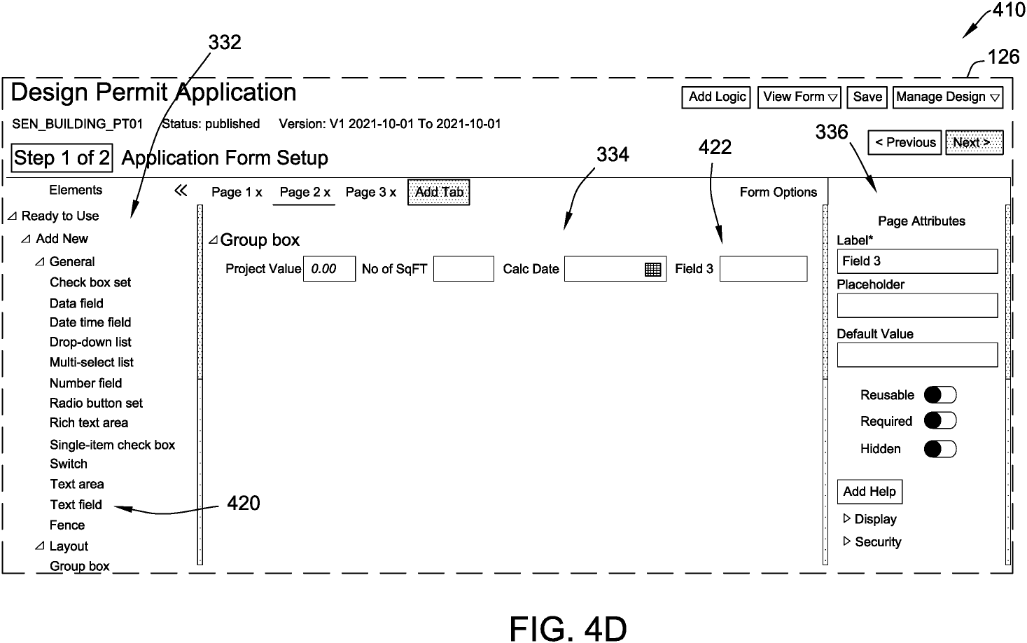

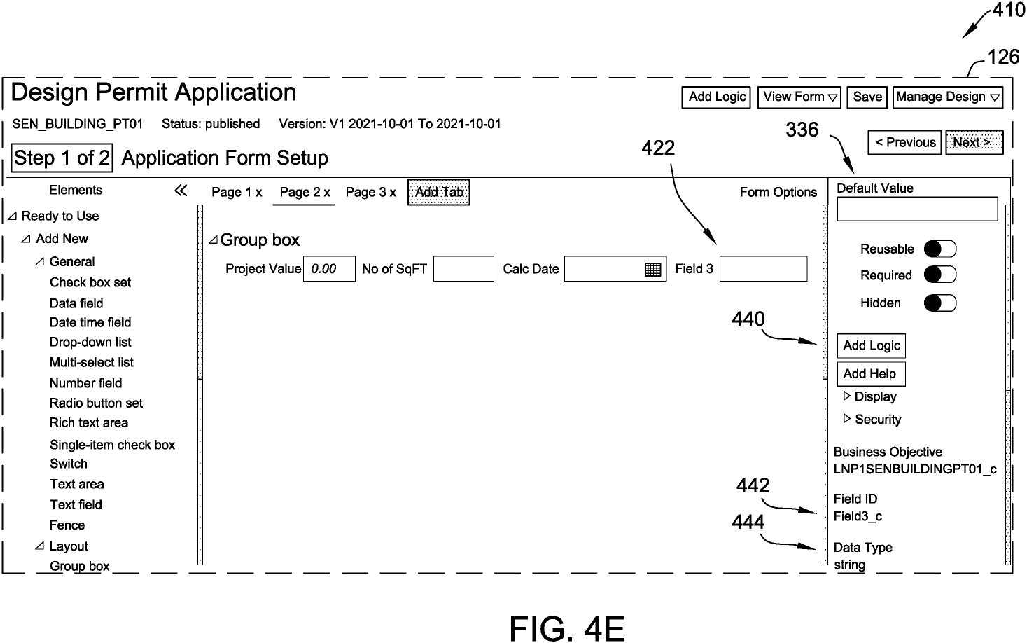

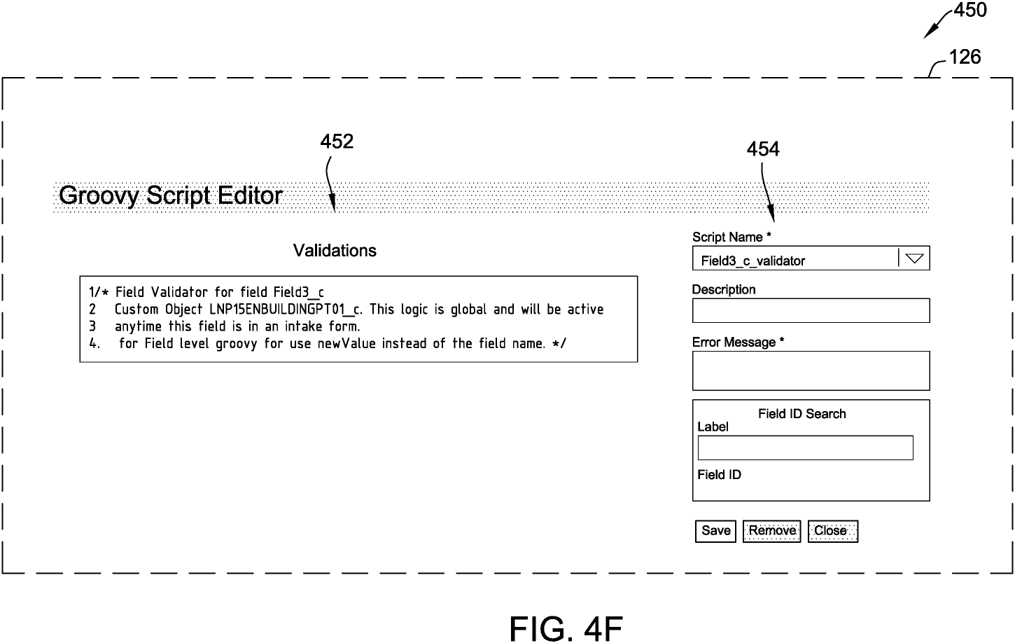

FIGS. 4A to 4F illustrate another sequence of screens provided by the admin interface 126 of the form management service 124 while the administrative user 142 adds a field 230 to the form 110. FIG. 4A illustrates a design screen 410 showing “Page 2” of an example form 110, which includes a “Group box” 412 (e.g., a field group 232) having three existing fields. In this example, the administrative user 142 is adding a field to this Group box 412 by dragging a data component from the components pane 332 into the group box 412 in the page design pane 334. In this view, the components pane 332 shows a condensed “Ready to Use” element and an “Add New” element. FIG. 4B illustrates a portion of the “Ready to Use” element after being expanded in the components pane 332. The sub-elements of the “Ready to Use” element include fields 230 and field groups 232 already defined and available for use. FIG. 4C illustrates the “Add New” element after being expanded in the components pane 332. The sub-elements of the “Add New” element include data components of various primitive data types that may be added as fields 230 onto the form 110.

In this example sequence, FIG. 4D illustrates the design screen 410 after the administrative user 142 drags a “Text field” 420 element from the “Add New” element of the components pane 332 and drops the text field 422 onto the page design pane 334. Upon addition of this new text field 422, the attributes pane 336 displays field attributes for the new field 422. FIG. 4E illustrates additional field attributes of the new field 422 in the components pane 332, including a “Field ID” 442 (e.g., a physical column name of the field in the database table), and a data type 444 of “string.” The attributes pane 336 also includes an “Add Logic” button that is used to add or edit user-defined actions 240 associated with the new field 422, including editing the user-defined instructions 250 of the action logic 242, trigger logic 244, and object function logic 246. FIG. 4F shows an edit screen 450 for editing the action logic 242 of a field validator for the new field 422. The edit screen 450 includes a text editor window 452 in which user-defined instructions 250 for the action logic 242 of the validator are entered by the administrative user 142. It should be understood that the displayed text is comment text and does not include any scripted instructions. The edit screen 450 also includes additional data associated with the validator, including a script name 454.

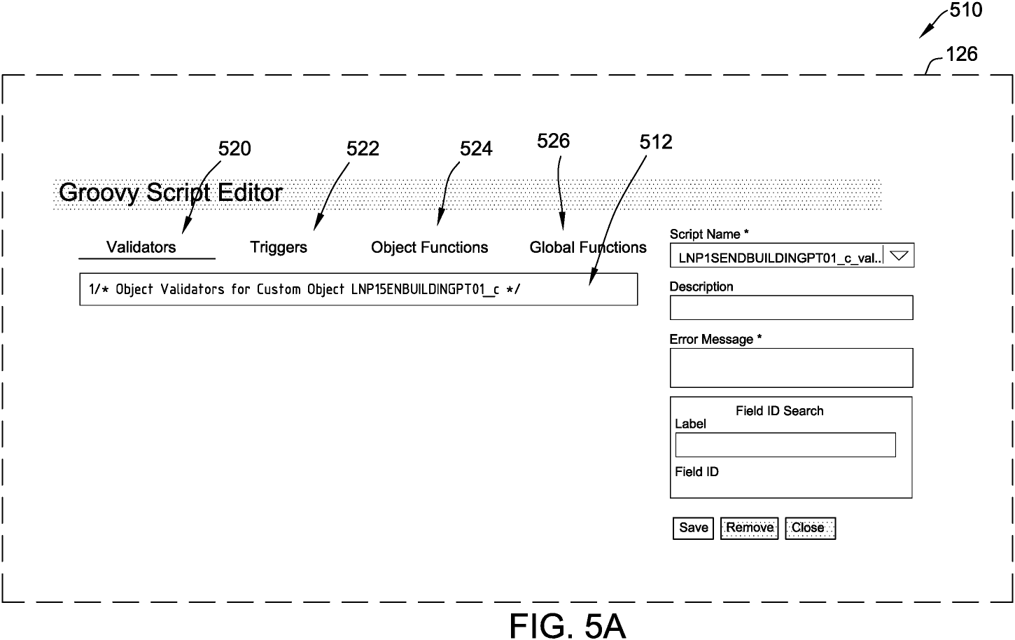

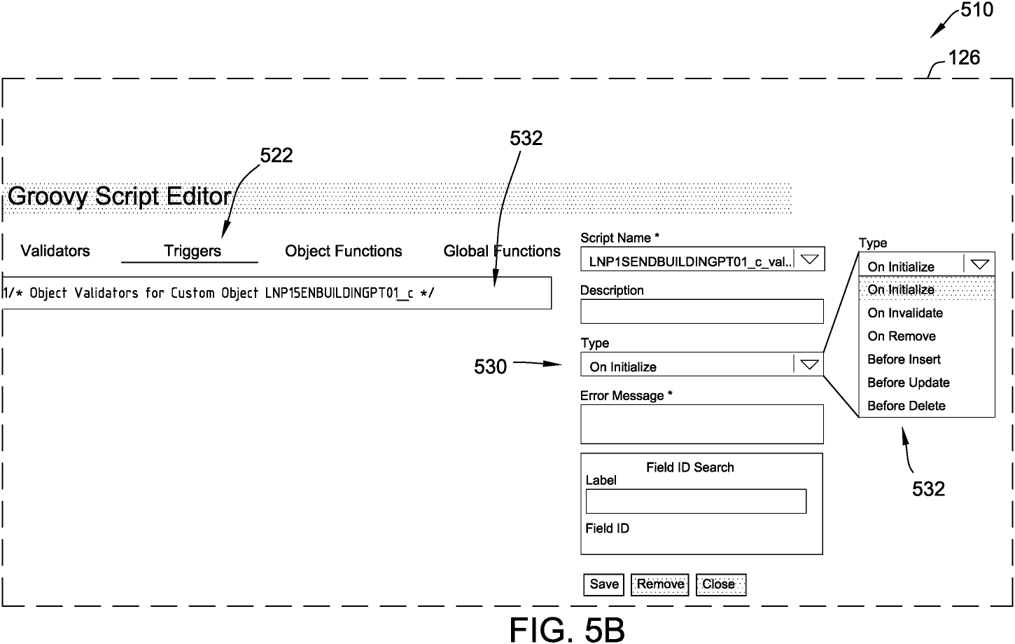

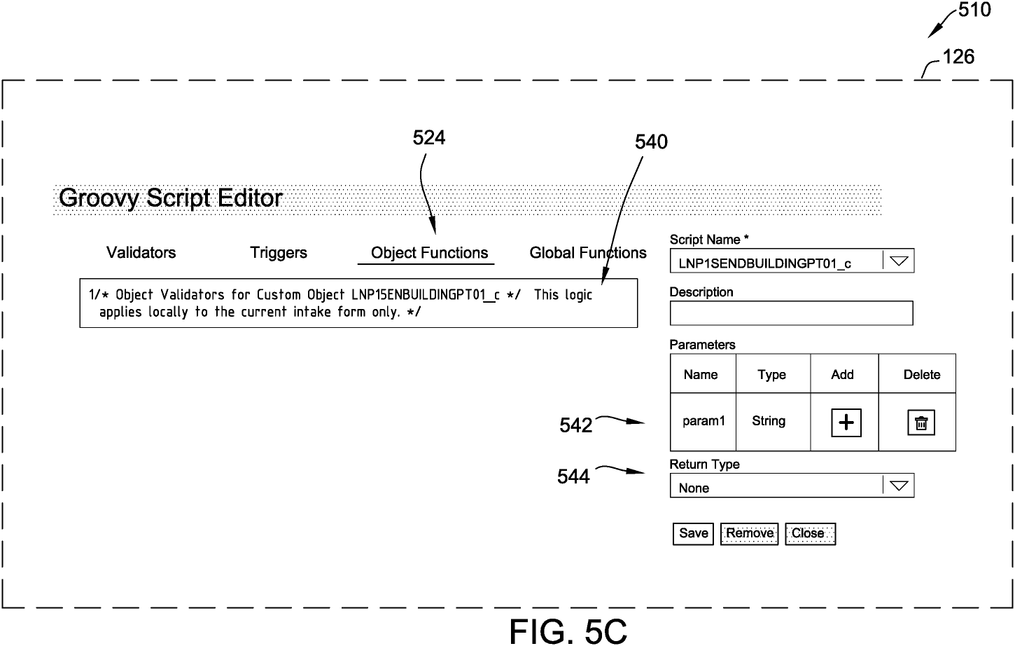

FIGS. 5A to 5C illustrate another sequence of screens provided by the admin interface 126 of the form management service 124 while the administrative user 142 edits a form-wide validator the form 110. FIG. 5A illustrates a design screen 510 displayed by the admin interface 126 after the administrative user 142 presses the Add Logic button 344 shown on the design interface 330 of FIG. 3C. The design screen 510 includes tabs for Validators tab 520 (e.g., action logic 242), tab Triggers 522 (e.g., trigger logic 244), Object Functions tab 524 (e.g., object function logic 246), and Global Functions tab 526 (e.g., global function logic 248). Selection of any of these tabs provides a text editor window 512 for editing the associated user-defined instructions for each type of logic 242-248. In this example, the Validators tab 520 is shown as selected.

FIG. 5B illustrates the Triggers tab 522 as selected within the design screen 510. In addition to a text editor window 532 for the Triggers tab 522, a Type drop-down list 530 is provided, the contents of which are also illustrated in FIG. 5B. The Type drop-down list 530 includes various selectable trigger conditions for this example validator, including “On Initialize,” “On Invalidate,” “On Remove,” “Before Insert,” “Before Update,” and “Before Delete,” each of which dictates when (e.g., upon what condition) the action logic 242 for this form-wide validator is to be executed. FIG. 5C illustrates the Object Functions tab 524 as selected within the design screen 510. The Object Functions tab 524 allows the administrative user 142 to configure object function logic 246 in the text editor window 540, as well as define input parameters 542 and a return data type 544 for the object function logic 246 that may be called by other user-defined instructions 250.

### 4. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field-programmable gate arrays (FPGAs), or network processing units (NPUs) that are persistently programmed to perform the techniques, or may include one or more general purpose hardware processors programmed to perform the techniques pursuant to program instructions in firmware, memory, other storage, or in combination. Such special-purpose computing devices may also combine custom hardware-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

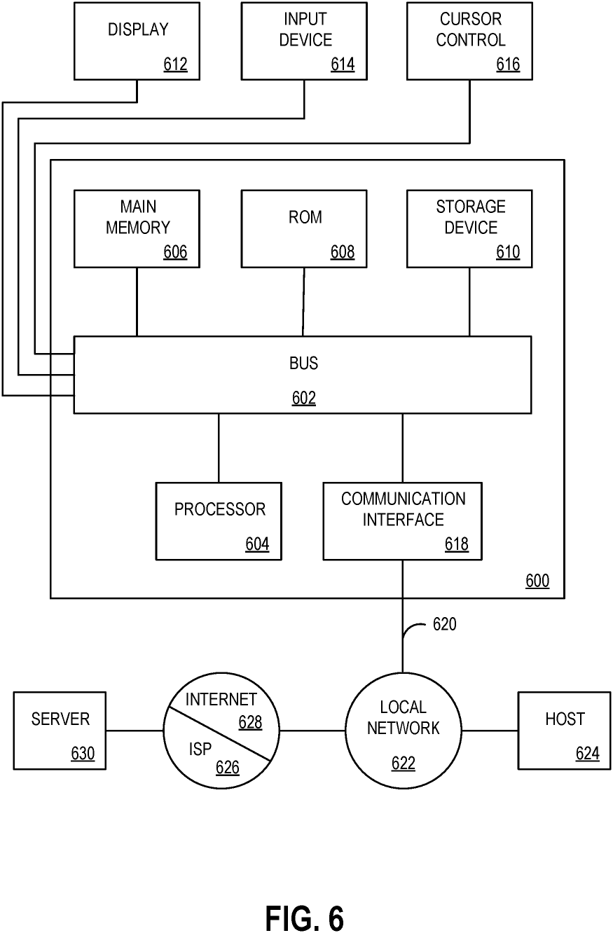

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a genera purpose microprocessor.

Computer system 600 also includes a main memory 606 such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire, and fiber optics, including the wires that comprise bus 602. Transmission media can also take the form of acoustic or light waves, such as those generated during radio-wave and infra-red data communications.

Various forms of media may be involved in carrying one or more instructions to processor 604 for execution. For example, the instructions may initially be carried on a magnetic disk or solid state drive of a remote computer. The remote computer can load the instructions into the remote computer’s dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electro-magnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620, and communication interface 618. In the Inernet example, a server 630 might transmit a requested code for an application program through Internet 628, ISP 626, local network 622, and communication interface 618. The received code may be executed by processor 604 as the code is received, and/or stored in storage device 610, or other non-volatile storage for later execution.

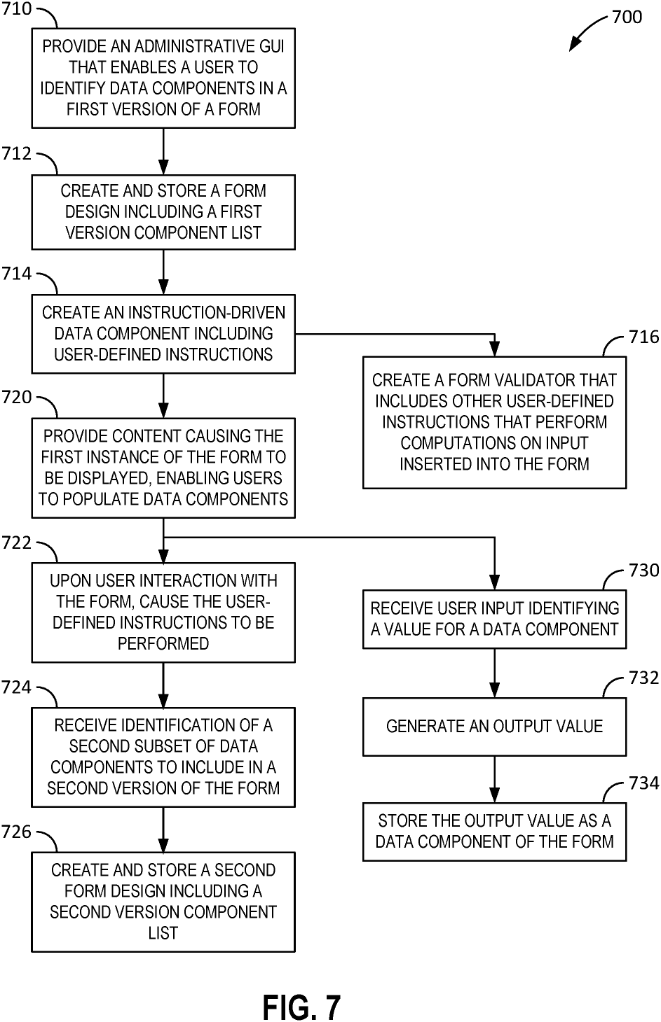

FIG. 7 is a flow chart illustrating an example computer-implemented method 700 of managing electronic forms such as the forms 110 shown and described in FIG. 1-5C. In some embodiments, the method 700 may be performed by one or more of the computing devices 122, 144, 154, 162 shown in FIG. 1. In the example embodiment, the method 700 includes providing first content configured to cause to be displayed an administrative graphical user interface (GUI) configured to enable a user to identify a first subset of data components from a form data structure definition to include in a first version of a form (Operation 710). The administrative GUI may be similar to the admin interface 126 or the user interface 128 shown in FIGS. 1-5C. The providing content in Operation 710 may include, for example, transmitting web browser-interpretable instructions (e.g., html, JavaScript, or the like) that, when processed by a browser application local to the receiving computing device 144, 154, causes the UI to be presented (e.g., displayed) to the user 142, 152 on their local device (e.g., displaying the screens shown in FIGS. 3A-6. This architecture may be referred to herein as a web-based or browser-based architecture, where the instructions for the UI are represented as interfaces 126, 128 of the form management service 124 shown in FIG. 1, for example. In client/server embodiments, the receiving computing device 144, 154 may have a client-side application locally installed that presents aspects of the UI. As such, the providing content in Operation 710 may include transmitting data to the computing device 144, 154 that is used by the client-side application to present the screens shown in FIGS. 3A-5C. It should be understood that the various operations that provide content is configured to cause something to be displayed in the systems and methods described herein can operate in the web-based architecture, the client/server-based architecture, or any such similar technology.

The method 700 also includes creating and storing a first form design (e.g., form design 112 of FIG. 1) including a first version component list identifying, from the form data structure definition, the first subset of data components as being included in the first version of the form (Operation 712). The method further includes creating, based on first user input, an instruction-driven data component included in the first version of the form, the instruction-driven data component including first user-defined instructions configured to be performed in response to an interaction with a first instance of the form (Operation 714). The instruction-driven data component may be similar to the user-defined actions 240 and user-defined instructions 250 shown in FIG. 2, and may include action logic 242, trigger logic 244, object function logic 246, or global function logic 248, or any combination thereof. In some embodiments, the method 700 may include creating, based on a second user input, a form validator associated with the first version of the form, the form validator includes second user-defined instructions that perform computations on input inserted into the first instance of the form (Operation 716).

The method 700 includes providing second content configured to cause to be displayed the first instance of the form, including content defined by one or more of the first subset of data components and enabling another user to populate one or more other of the first subset of data components (Operation 720). The first instance of the form may be transmitted for display, for example, as a part of the user interface 128 provided to the form users 152 via computing devices 154. The method 700 also includes causing to be performed, upon user interaction with the first instance of the form, the first user-defined instructions to generate an output (Operation 722). In some embodiments, the first user-defined instructions are performed on data inserted into the first instance of the form. In some embodiments, the first user-defined instructions are performed when any data component in the first instance of the form is changed. In some embodiments, performing the first user-defined instructions includes causing communication with a third-party application service to perform a third-party service. In some embodiments, when to perform the first user-defined instructions is further based on performing second user-defined instructions. In some embodiments, the first user-defined instructions includes a reference to a function from an object function library.

In some embodiments, the method 700 includes receiving identification of a second subset of data components, of the form data structure definition, to include in a second version of the form, the second subset of data components being different than the first subset of data components (Operation 724) and creating and storing a second form design including a second version component list identifying, within the form data structure definition, the second subset of data components as being included in the second version of the form (Operation 726). In some embodiments, consuming the first data component to generate the output value further includes receiving second user-defined instructions that includes instructions for generating the output value and, upon receiving the second user input, automatically triggering execution of the second user-defined instructions to generate the output value based on the value of the first data component.

In some embodiments, the method 700 includes receiving a second user input identifying a value provided for a first data component of the first instance of the form (Operation 730), consuming the first data component to generate an output value based on the value of the first data component (Operation 732), and storing the output value as a second data component of the first instance of the form (Operation 734).

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A smart form management system comprising:
at least one processor executing instructions that cause the at least one processor to:
provide first content configured to cause to be displayed an administrative graphical user interface (GUI) configured to enable an administrative user to identify a first subset of data components from a form data structure definition to include in a first version of a form;
create and store a first form design including a first version component list identifying, from the form data structure definition, the first subset of data components as being included in the first version of the form;
create, based on a first user input from the administrative user, an instruction-driven data component included as one data component of the first subset of data components included in the first version of the form, the instruction-driven data component including first user-defined instructions provided by the first user input from the administrative user, the first user-defined instructions being configured to be performed in response to an interaction of an end user with a first instance of the form;
provide second content configured to cause to be displayed the first instance of the form to the end user, including content defined by one or more of the first subset of data components and enabling the end user to populate one or more other of the first subset of data components; and
upon user interaction with the first instance of the form by the end user, cause to be performed the first user-defined instructions to generate an output.

2. The smart form management system of claim 1, wherein the first user-defined instructions are performed on data inserted into the first instance of the form.

3. The smart form management system of claim 1, wherein the first user-defined instructions are performed when any data component in the first instance of the form is changed.

4. The smart form management system of claim 1, wherein the instructions further cause the at least one processor to:
create, based on a second user input, a form validator associated with the first version of the form, the form validator includes second user-defined instructions that perform computations on input inserted into the first instance of the form.

5. The smart form management system of claim 1, wherein performing the first user-defined instructions includes causing communication with a third-party application service to perform a third-party service.

6. The smart form management system of claim 1, wherein when to perform the first user-defined instructions is further based on performing second user-defined instructions.

7. The smart form management system of claim 1, wherein the instructions further cause the at least one processor to:
receive a second user input identifying a value provided for a first data component of the first instance of the form;
consume the first data component to generate an output value based on the value of the first data component; and
store the output value as a second data component of the first instance of the form.

8. The smart form management system of claim 7, wherein consuming the first data component to generate the output value further comprises:
receiving second user-defined instructions that includes instructions for generating the output value; and
upon receiving the second user input, automatically trigger execution of the second user-defined instructions to generate the output value based on the value of the first data component.

9. The smart form management system of claim 1, wherein the instructions further cause the at least one processor to:
receive identification of a second subset of data components, of the form data structure definition, to include in a second version of the form, the second subset of data components being different than the first subset of data components; and
create and store a second form design including a second version component list identifying, within the form data structure definition, the second subset of data components as being included in the second version of the form.

10. The smart form management system of claim 1, wherein the first user-defined instructions include a reference to a function from an object function library.

11. A computer-implemented method of managing electronic forms, the method comprising:
providing first content configured to cause to be displayed a user interface configured to enable a form administration user to identify a first subset of data components from a form data structure definition to include in a first version of a form;
creating and storing a first form design including a first version component list identifying, from the form data structure definition, the first subset of data components as being included in the first version of the form;
creating, based on a first user input from the form administration user, an instruction-driven data component included as one data component of the first subset of data components included in the first version of the form, the instruction-driven data component being provided by the first user input from the form administrative user and including one or more of a trigger condition and a triggered action that includes first user-defined instructions configured to be performed in response to an interaction of a form user with a first instance of the form;
providing second content configured to cause to be displayed the first instance of the form to the form user, including content defined by one or more of the first subset of data components and enabling the form user to populate one or more other of the first subset of data components; and
upon user interaction with the first instance of the form by the form user, causing the first user-defined instructions to be performed to generate an output.

12. The method of claim 11, wherein performing the first user-defined instructions includes communicating with a third-party application service to perform a third-party service.

13. The method of claim 12, wherein communicating with the third-party application service includes receiving one or more data elements from the third-party application service, the method further comprising populating at least one data component on the first instance of the form based on the one or more data elements received from the third-party application service.

14. The method of claim 12, wherein communicating with the third-party application service includes transmitting at least one data component to the third-party application service.

15. The method of claim 11 further comprising:
receiving identification of a second subset of data components, of the form data structure definition, to include in a second version of the form, the second subset of data components being different than the first subset of data components; and
creating and storing a second form design including a second version component list identifying, within the form data structure definition, the second subset of data components as being included in the second version of the form.

16. A non-transitory computer-readable medium storing instructions that, when executed by at least one processor, cause the at least one processor to:
provide first content configured to cause to be displayed an administrative graphical user interface (GUI) configured to enable an administrative user to identify a first subset of data components from a form data structure definition to include in a first version of a form;
create and store a first form design including a first version component list identifying, from the form data structure definition, the first subset of data components as being included in the first version of the form;
create and store a second form design including a second version component list identifying, from the form data structure definition, a second subset of data components as being included in a the second version of the form, the second subset of data components being different than the first subset of data components;
create, based on a user input from the administrative user, an instruction-driven data component included as one data component of the at least one of the first subset of data components included in the first version of the form and the second subset of data components included in the second version of the form, the instruction-driven data component including user-defined instructions provided by the user input from the administrative user, the user-defined instructions being configured to be performed in response to an interaction of an end user with a first instance of the form;
create the first instance of the form based on one of the first form design and the second form design;
provide second content configured to cause to be displayed the first instance of the form to the end user, including content defined by one or more of the first subset of data components; and
upon user interaction with the first instance of the form by the end user, cause to be performed the user-defined instructions to generate an output.

17. The non-transitory computer-readable medium of claim 16, wherein the form data structure definition includes a plurality of fields, each field of the plurality of fields being associated with a column of a database table in a relational database.

18. The non-transitory computer-readable medium of claim 17, wherein the first instance of the form is associated with a first row in the database table.

19. The non-transitory computer-readable medium of claim 18, wherein one or more cells in the first row of the database table is associated with a field of the form.

20. The non-transitory computer-readable medium of claim 17, wherein creating and storing the second form design includes modifying a field included in the first form design, the field in the first form design is associated with a first column in the database table having a first data type, wherein modifying the field includes:
creating a new column with a data type matching the first data type;
creating the second form design as a clone of the first form design;
deleting the first column from the second form design; and
adding the new column to the second form design.
